(19) United States
(12) Patent Application Publication
(10) Pub. No.: US 2018/0150857 A1
(43) Pub. Date: May 31, 2018

(54) APPARATUS AND METHOD FOR PROCESSING TENDER OF AGGREGATE POWER PLANT

(71) Applicant: ELECTRONICS AND TELECOMMUNICATIONS RESEARCH INSTITUTE, Daejeon (KR)

(72) Inventors: Ji-Hyun LEE, Daejeon (KR); Young-Mee SHIN, Daejeon (KR); Il-Woo LEE, Daejeon (KR)

(21) Appl. No.: 15/786,711

(22) Filed: Oct. 18, 2017

(30) Foreign Application Priority Data
Nov. 30, 2016 (KR) 10-2016-0161821
Sep. 21, 2017 (KR) 10-2017-0121935

(51) Int. Cl. G06Q 30/02; G06Q 30/06; H02J 3/38

(52) U.S. Cl. CPC G06Q 30/0206; G05B 15/02; H02J 3/385; G06Q 30/0611

(57) ABSTRACT

An apparatus and method for processing a tender of an aggregate power plant. The apparatus for processing a tender of an aggregate power plant includes an aggregate power plant configuration management unit for generating an aggregate profile by forming an aggregate power plant by grouping distributed energy resources for participating in a power market, a monitoring unit for reconfiguring the aggregate profile by monitoring the distributed energy resources, a tender-processing unit for calculating an offering amount of the aggregate power plant using the aggregate profile, and a tender weight calculation unit for calculating a weight coefficient based on meteorological information in order to adjust the offering amount and for providing the weight coefficient to the tender-processing unit.

### CROSS REFERENCE TO RELATED APPLICATIONS

This application claims priority to Korean Patent Application No. 10-2016-0161821, filed Nov. 30, 2016, and No. 10-2017-0121935, filed Sep. 21, 2017, which are hereby incorporated by reference in their entirety into this application.

### BACKGROUND OF THE INVENTION

### 1. Technical Field

The present invention relates generally to technology for a tender for electric power, and more particularly to technology for processing a tender of an aggregated power plant.

### 2. Description of Related Art

In a smart grid, an electronic bidding system is a system for receiving sales orders in order to sell power generated by power generators that participate in a power market.

An entity that possesses a power generator basically inputs information about the amount of power that can be actually produced from the power generator as an initial value and submits an offer. Here, an aggregated power plant that consists of multiple small-scale distributed energy resources may determine the amount of power that can be supplied by itself using the sales volume that is calculated as the sum of the amounts of power that can be generated by the small-scale distributed energy resources.

In order to enable small-scale distributed energy resources to participate in power trade, the aggregate power plant needs to be entrusted to perform transactions of power by the small-scale distributed energy resources. In this case, the aggregated power plant may receive information about the amount of power generated by the respective small-scale distributed energy resources therefrom, but the amount of power to be generated may be determined by the administrator of the aggregate power plant based on the maximum power generation capacity and the characteristics of the power generators.

Here, in order to participate in a tender, the aggregate power plant needs to select an offering amount input mode and requires a method for receiving an order amount in the selected mode.

Meanwhile, Korean Patent No. 10-1676427, titled “Power bidding profile system”, discloses a power bidding profile system that runs a profile by adjusting an offering amount by incorporating power generator performance information in the profile when a tender for an amount of power per unit time is made.

### SUMMARY OF THE INVENTION

An object of the present invention is to participate in a tender for power generation by inputting and storing an offering amount in an aggregate power plant depending on a selected power amount input mode.

Another object of the present invention is to form an aggregate power plant such that small-scale distributed energy resources participate in a power trade market and are used as power generation resources even though they are difficult to manage.

A further object of the present invention is to provide various input modes for a tender of an aggregated power plant.

In order to accomplish the above objects, an apparatus for processing a tender of an aggregate power plant according to an embodiment of the present invention includes an aggregate power plant configuration management unit for generating an aggregate profile by forming an aggregate power plant by grouping distributed energy resources for participating in a power market; a monitoring unit for reconfiguring the aggregate profile by monitoring the distributed energy resources; a tender-processing unit for calculating an offering amount of the aggregate power plant using the aggregate profile; and a tender weight calculation unit for calculating a weight coefficient based on meteorological information in order to adjust the offering amount, and providing the weight coefficient to the tender-processing unit.

Here, the tender weight calculation unit may calculate a weight coefficient of at least one of a season-based weight, an insolation-based weight, and a weather-based weight based on the meteorological information.

Here, the tender weight calculation unit may calculate the weight coefficient of the insolation-based weight based on average horizontal insolation during a preset period before a day for which a weight is requested to be calculated.

Here, the tender weight calculation unit may adjust the insolation-based weight using a weight coefficient of a time-based weight, which is calculated from information about insolation for each hour on the day for which the weight is requested to be calculated with reference to the meteorological information.

Here, the tender-processing unit may calculate the offering amount in such a way that an initial offering amount is calculated based on meteorological information of a day before a desired tender date and an adjusted offering amount is calculated by adjusting the initial offering amount based on meteorological information of the desired tender date.

Here, the tender-processing unit may calculate average power generation per hour for each season using previously the stored information about an amount of power generated by the aggregate power plant in past.

Here, when there is no information about the amount of power generated by the aggregate power plant in the past, the tender-processing unit may calculate the average power generation per hour for each season using a maximum and a minimum power generation capacity of the distributed energy resources that form the aggregate power plant.

Here, the tender-processing unit may calculate the initial offering amount using the average power generation per hour and the weight coefficients of the season-based weight and the insolation-based weight based on the meteorological information of the day before the desired tender date.

Here, the tender-processing unit may calculate the adjusted offering amount by adjusting the initial offering amount using the weight coefficients of the weather-based weight and the insolation-based weight based on the meteorological information of the desired tender date.

Here, the tender-processing unit may generate a final tender proposal of the aggregate power plant by generating an initial tender proposal for the initial offering amount and generating a tender proposal again for the adjusted offering amount.

Also, in order to accomplish the above objects, a method for processing a tender of an aggregate power plant, in which an apparatus for processing a tender of an aggregate power plant is used, according to an embodiment of the present invention includes generating an aggregate profile by forming an aggregate power plant by grouping distributed energy resources for participating in a power market; reconfiguring the aggregate profile by monitoring the distributed energy resources; and calculating an offering amount of the aggregate power plant using the aggregate profile.

Here, calculating the offering amount may be configured to calculate a weight coefficient of at least one of a season-based weight, an insolation-based weight, and a weather-based weight based on meteorological information.

Here, calculating the offering amount may be configured to calculate the weight coefficient of the insolation-based weight based on average horizontal insolation during a preset period before a day for which a weight is requested to be calculated.

Here, calculating the offering amount may be configured to adjust the insolation-based weight using a weight coefficient of a time-based weight, which is calculated from information about insolation for each hour on the day for which the weight is requested to be calculated with reference to the meteorological information.

Here, calculating the offering amount may be configured to calculate the offering amount in such a way that an initial offering amount is calculated based on meteorological information of a day before a desired tender date and an adjusted offering amount is calculated by adjusting the initial offering amount based on meteorological information of the desired tender date.

Here, calculating the offering amount may be configured to calculate average power generation per hour for each season using the previously stored information about an amount of power generated by the aggregate power plant in past.

Here, calculating the offering amount may be configured to calculate the average power generation per hour for each season using a maximum and a minimum power generation capacity of the distributed energy resources that form the aggregate power plant when there is no information about the amount of power generated by the aggregate power plant in the past.

Here, calculating the offering amount may be configured to calculate the initial offering amount using the average power generation per hour and the weight coefficients of the season-based weight and the insolation-based weight based on the meteorological information of the day before the desired tender date.

Here, calculating the offering amount may be configured to calculate the adjusted offering amount by adjusting the initial offering amount using the weight coefficients of the weather-based weight and the insolation-based weight based on the meteorological information of the desired tender date.

Here, calculating the offering amount may be configured to generate a final tender proposal of the aggregate power plant by generating an initial tender proposal for the initial offering amount and generating a tender proposal again for the adjusted offering amount.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows an apparatus for processing a tender of an aggregate power plant according to an embodiment of the present invention;

FIG. 2 is a block diagram that specifically shows an example of the aggregate power plant configuration management unit illustrated in FIG. 1;

FIG. 3 is a block diagram that specifically shows an example of the monitoring unit illustrated in FIG. 1;

FIG. 4 is a block diagram that specifically shows an example of the tender-processing unit illustrated in FIG. 1;

FIG. 5 is a block diagram that specifically shows an example of the tender statistics calculation unit illustrated in FIG. 1;

FIG. 6 is a flowchart that shows a method for processing a tender of an aggregate power plant according to an embodiment of the present invention;

FIG. 7 is a flowchart that specifically shows an example of the step of forming an aggregate power plant, illustrated in FIG. 6;

FIG. 8 is a flowchart that specifically shows an example of the monitoring step, illustrated in FIG. 6;

FIG. 9 is a flowchart that specifically shows an example of the step of making an initial tender, illustrated in FIG. 6;

FIG. 10 is a flowchart that specifically shows an example of the step of changing a tender, illustrated in FIG. 6;

FIG. 11 is a view that shows an interface for selecting an operation mode for calculating an offering amount of an aggregate power plant according to an embodiment of the present invention; and

FIG. 12 is a block diagram that shows a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising”, and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

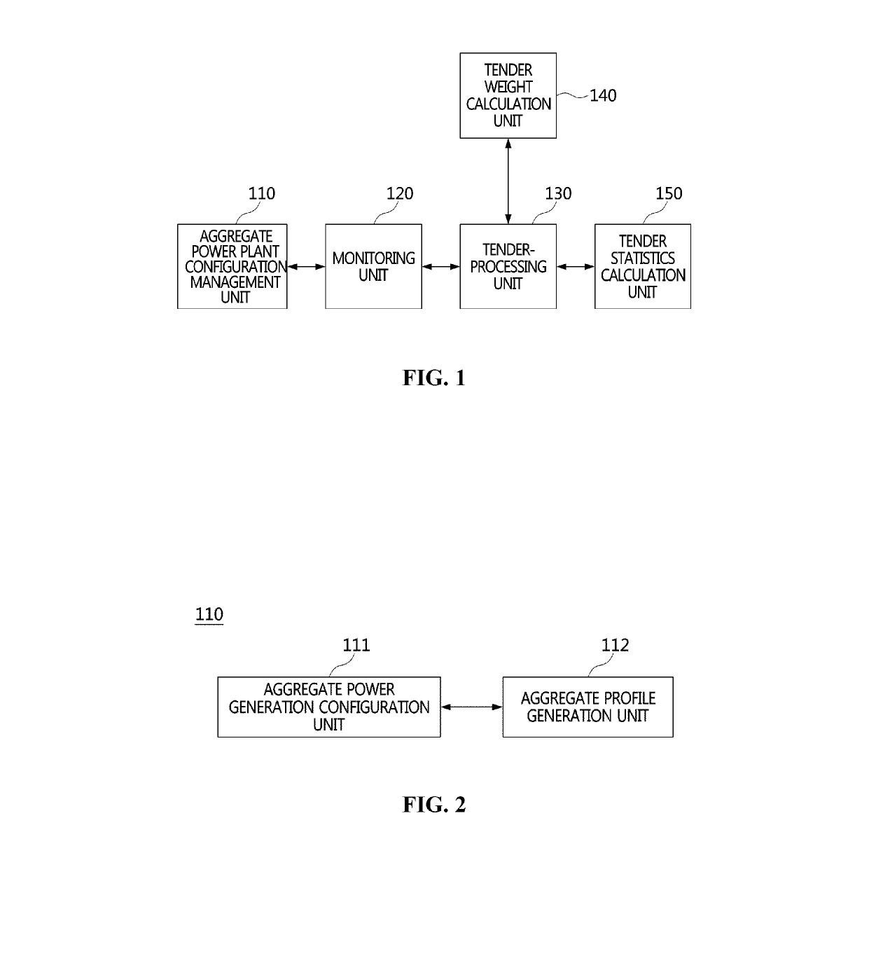

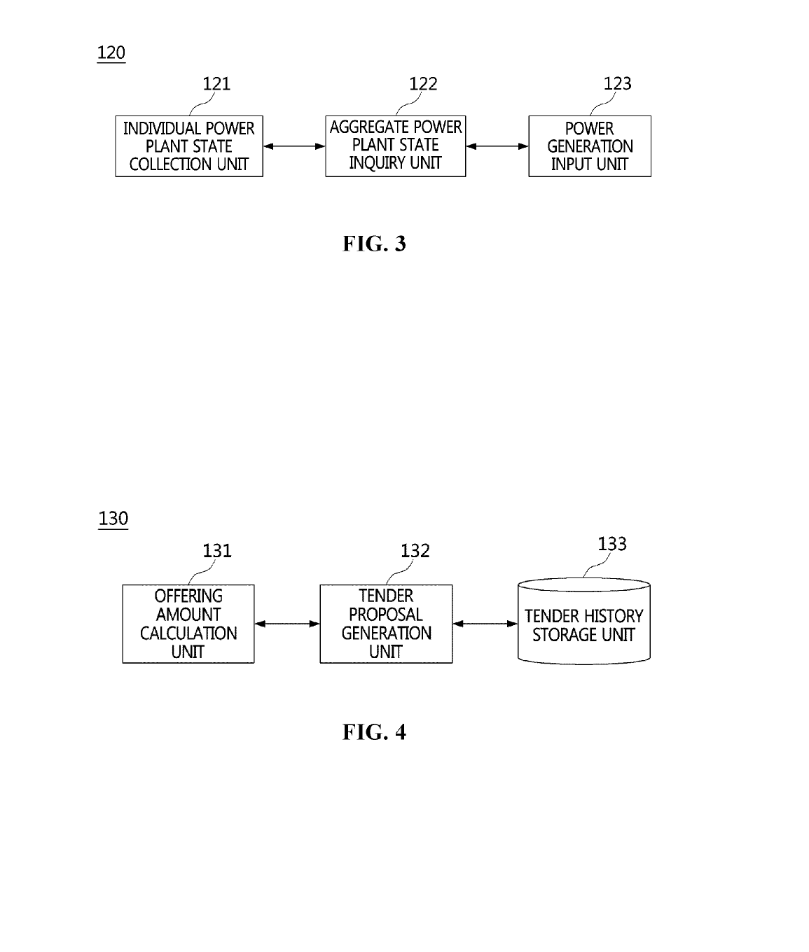

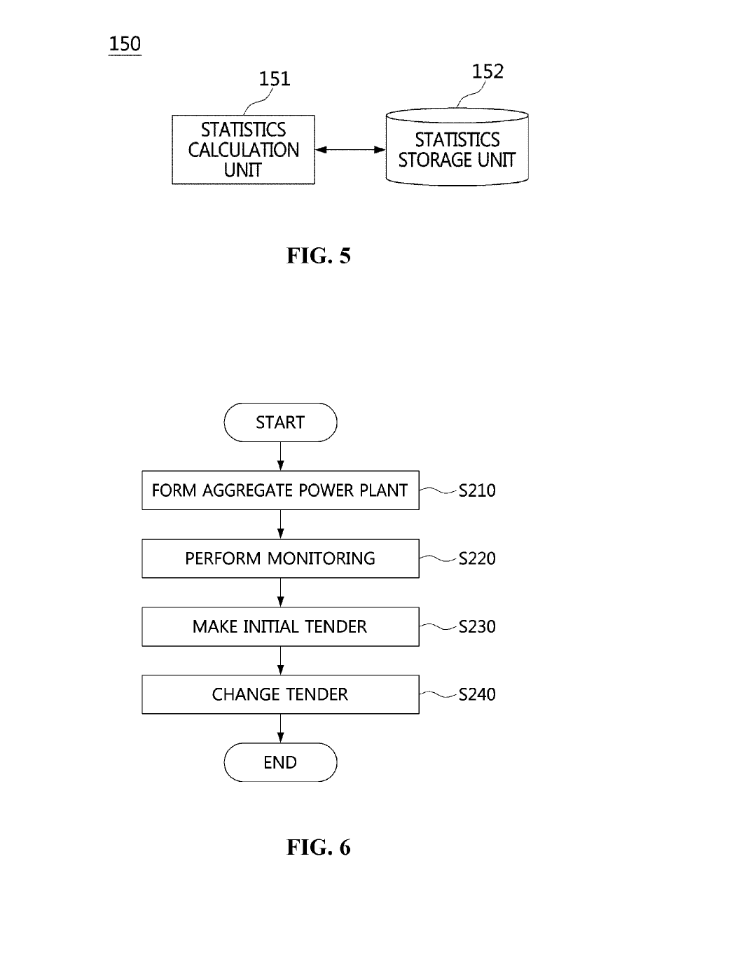

FIG. 1 is a block diagram that shows an apparatus for processing a tender of an aggregate power plant according to an embodiment of the present invention. FIG. 2 is a block diagram that specifically shows an example of the aggregate power plant configuration management unit illustrated in FIG. 1. FIG. 3 is a block diagram that specifically shows an example of the monitoring unit illustrated in FIG. 1. FIG. 4 is a block diagram that specifically shows an example of the tender-processing unit illustrated in FIG. 1. FIG. 5 is a block diagram that specifically shows an example of the tender statistics calculation unit illustrated in FIG. 1.

Referring to FIG. 1, the apparatus 100 for processing a tender of an aggregate power plant according to an embodiment of the present invention includes an aggregate power plant configuration management unit 110, a monitoring unit 120, a tender-processing unit 130, a tender statistics calculation unit 140, and a tender weight calculation unit 150.

The aggregate power plant configuration management unit 110 may generate an aggregate profile by forming an aggregate power plant by grouping distributed energy resources for participating in a power market.

Here, the aggregate power plant configuration management unit 110 may form the aggregate power plant by selecting one or more distributed energy resources that match aggregate power generation characteristics.

Referring to FIG. 2, the aggregate power plant configuration management unit 110 may include an aggregate power generation configuration unit 111 and an aggregate profile generation unit 112.

The aggregate power generation configuration unit 111 may form an aggregate power plant by grouping individual small-scale distribute resources. A small-scale distributed energy resource may be registered as a constituent power generator for forming the aggregate power plant by entering into a contract, and the registered small-scale distributed energy resource may be included in the aggregate power plant.

Here, the aggregate power plant configuration unit 111 may generate multiple aggregate power plants, each of which consists of two or more small-scale distributed energy resources.

Here, the owner of a small-scale distributed energy resource may be requested to enter into a contract that is necessary in order for the aggregate power plant configuration unit 111 to form an aggregate power plant.

Here, the aggregate power plant configuration unit 111 may start an electronic contract by receiving information about the small-scale distributed energy resources.

Here, when the electronic contract is concluded, the aggregate power plant configuration unit 111 may form an aggregate power plant by selecting the contracted small-scale power generators.

Here, the aggregate power plant configuration unit 111 may additionally include a small-scale distributed energy resource that is newly contracted or has been contracted in advance in the aggregate power plant consisting of one or more small-scale distributed energy resources, and may thereby form an aggregate power plant that matches aggregate power generation characteristics.

For example, the aggregate power generation characteristics may be the power generation capacity of small-scale distributed energy resources, the purpose thereof, the region in which the small-scale distributed energy resources are located, and the like.

The aggregate profile generation unit 112 may form an aggregate power generation resource by collecting small-scale distributed energy resources registered in the power market.

For example, the aggregate profile generation unit 112 collects the configuration information of small-scale distributed energy resources, such as the power generator license, the location, the type, the capacity, a watt-hour meter number, and the like, and may form the configuration information of the aggregate power generation resource, such as the name of an aggregate power plant, the total capacity thereof, the location thereof, the number of power generation resources therein, an offering amount per hour, an offering amount for each season, an offering amount input mode, and the like.

Here, the aggregate profile generation unit 112 may generate an aggregate profile based on the configuration information of the aggregate power generation resource, which is acquired as the result of collecting the configuration information of the small-scale distributed energy resources.

The monitoring unit 120 may reconfigure the aggregate profile by monitoring the distributed energy resources.

Referring to FIG. 3, the monitoring unit 120 may include an individual generator state collection unit 121, an aggregate power plant state inquiry unit 122, and a power generation input unit 123.

The individual generator state collection unit 121 may collect and store information about the states of individual resources and the current condition of power generation by individual resources.

The aggregate power plant state inquiry unit 122 may monitor, in real time, the state of each of the small-scale distributed energy resources that form the aggregate power plant and the amount of power generated by each of the small-scale distributed energy resources.

Here, the aggregate power plant state inquiry unit 122 monitors the distributed energy resources included in the aggregate power plant, and may monitor the amount of power generated only by distributed energy resources that are operating normally.

For example, the aggregate power plant state inquiry unit 122 may monitor the distributed energy resources every five minutes, and may collect and manage information about whether each of the distributed energy resources is operating normally. Here, the aggregate power plant state inquiry unit 122 may not receive information about power generation from a distributed energy resource in an abnormal state or from a distributed energy resource for which regular inspection is being performed.

Here, the aggregate power plant state inquiry unit 122 may monitor the overall power generation state, including information about whether the power generation state of the aggregate power plant is normal, whether small-scale distributed energy resources included therein are malfunctioning, and the like.

Here, the aggregate power plant state inquiry unit 122 may perform monitoring of the individual small-scale distributed energy resources in parallel with monitoring of the aggregate power plant.

Here, the aggregate power plant state inquiry unit 122 may reconfigure the aggregate profile by changing the composition of the aggregate power plant such that the amount of power generated by the normally operating distributed energy resources matches the installed capacity.

The power generation input unit 123 may collect information about real-time power generation and cumulative power generation by reading a power-hour meter, which measures the amount of power generated by each of the small-scale distributed energy resources, every five minutes.

Here, the power generation input unit 123 may deliver the information about the real-time power generation to the tender-processing unit 130.

The information about the real-time power generation may be used as basic data for calculating an estimated offering amount for each hour.

The tender-processing unit 130 may calculate an offering amount of the aggregate power plant using the aggregate profile.

Referring to FIG. 4, the tender-processing unit 130 may include an offering amount calculation unit 131, a tender proposal generation unit 132, and a tender history storage unit 133.

The offering amount calculation unit 131 may calculate an offering amount for each hour to be offered by the aggregate power plant.

The offering amount may include an initial offering amount and an adjusted offering amount.

The initial offering amount may be acquired in such a way that the average amount of power generated each hour by the aggregate power plant is adjusted depending on meteorological information of the day before the desired tender date.

The adjusted offering amount may be acquired by modifying the initial offering amount based on the varying local weather information and insolation information on the desired tender date after the initial tender.

Here, the offering amount calculation unit 131 may calculate the amount of power that is expected to be generated.

Here, the offering amount calculation unit 131 may receive basic data and calculate power generation using a power generation calculation algorithm in order to estimate the amount of power to be generated by the aggregate power plant.

Here, the basic data may include information acquired by monitoring the aggregate power plant, information about the amount of power generated by small-scale distributed energy resources, which are currently being monitored, and information about the minimum and maximum power generation capacities, which were input when the small-scale distributed energy resource was contracted for the aggregate power generation.

Here, the offering amount calculation unit 131 may calculate an offering amount based on the input information about the power generation in an operation mode selected for calculating the offering amount of the aggregate power plant.

Here, the offering amount calculation unit 131 may calculate the offering amount using any of three operation modes.

The three operation modes for calculating the offering amount may include a manual input mode, an automatic input mode, and an automatic adjustment mode.

Also, the three operation modes are input as configuration information when the aggregate power plant is formed, and may be used to identify an offering amount input method when the offering amount is calculated.

Here, the offering amount calculation unit 131 may enable the owner of the small-scale distributed energy resource to input the desired amount of power to sell (the amount of power to generate) and the desired price thereof using the manual input mode.

Here, the offering amount calculation unit 131 may automatically calculate the amount of power to be sold (the amount of power to be generated) using the automatic input mode and the automatic adjustment mode.

Here, when the automatic input mode is selected as the operation mode, the method in which the offering amount calculation unit 131 calculates the amount of power to be sold may vary depending on whether information about the amount of power generated in the corresponding month in the past years includes information about the amount of power generated for each hour.

For example, the offering amount calculation unit 131 may categorize power generation stages into a stop stage, a maximum stage, and a minimum stage, and may arrange the stop stage, the minimum stage, the maximum stage, the minimum stage, and the stop stage over 24 hours in the order in which they are listed above.

Here, in the automatic input mode, when there is information about the amount of power generated in the corresponding month in the past years, the offering amount calculation unit 131 divides the year into periods of spring, summer, fall, and winter, and may calculate average power generation per hour for the preset period using the past power generation information.

Here, in the automatic input mode, the offering amount calculation unit 131 may input the average power generation per hour as the power generation of the maximum stage, among the power generation stages.

Here, in the automatic input mode, the offering amount calculation unit 131 may input ‘0’ as the power generation of the stop stage, among the power generation stages.

Here, in the automatic input mode, the offering amount calculation unit 131 may input the result of multiplying the average power generation per hour by the weight coefficient of a season-based weight as the power generation of the minimum stage, among the power generation stages.

Here, in the automatic input mode, when there is no information about the amount of power generated in the past, the offering amount calculation unit 131 may calculate the average power generation per hour from the median value of the maximum and the minimum power generation capacity, which were input when the small-scale distributed energy resource was registered.

Here, the calculated average power generation per hour may be a temporary value.

Here, the accuracy of the initial offering amount corresponding to the average power generation per hour, which is calculated using the past power generation information, may increase with the accumulation of the power generation information.

Also, the offering amount calculation unit 131 may modify the average power generation per hour.

The tender weight calculation unit 140 may calculate a weight coefficient for modifying the average power generation per hour.

Here, the tender weight calculation unit 140 may store meteorological information for calculating a weight (for example, insolation information and weather information) therein, and may receive the same from a server device for providing meteorological information.

Here, the tender weight calculation unit 140 may calculate a weight coefficient of at least one of a season-based weight, an insolation-based weight, and a weather-based weight based on the meteorological information.

Here, the tender weight calculation unit 140 may calculate a weight coefficient for modifying the average power generation per hour and provide the weight coefficient to the tender-processing unit 130.

Here, the tender weight calculation unit 140 may calculate a season-based weight, an insolation-based weight, and a time-based weight respectively based on the season, insolation, and time.

For example, the tender weight calculation unit 140 may calculate the weight coefficient of the season-based weight for the season in which the desired tender date is included.

Here, the tender weight calculation unit 140 may select the weight coefficient of the season-based weight that represents the corresponding season, as shown in Table 1.

TABLE 1

range

| | spring | summer | fall | winter |
|---|---|---|---|---|
| weight | 0.8 | 1.5 | 1.0 | 0.3 |

For example, the tender weight calculation unit 140 may select the weight coefficient of the season that includes the day for which a weight is requested by the tender-processing unit 130 (for example, the season including the desired tender date and the day before the desired tender date).

Also, the tender weight calculation unit 140 may calculate the weight coefficient of the insolation-based weight based on the average horizontal insolation for a preset period (for example: a week) before the desired tender date.

Here, the tender weight calculation 140 may select the weight coefficient of the insolation-based weight that represents the range of insolation, as shown in Table 2.

TABLE 2

| | range | | | | |
|---|---|---|---|---|---|
| | less | equal to or | equal to or | equal to or | equal to or |
| | than | greater than 1.0 | greater than 2.0 | greater than 3.0 | greater than 4.0 |
| | 1.0 | and less than 2.0 | and less than 3.0 | and less than 4.0 | and less than 5.0 |
| weight | 0.8 | 0.9 | 1.0 | 1.1 | 1.2 |

For example, the insolation-based weight may be determined to be 0.8, 0.9, 1.0, 1.1, and 1.2 for the respective cases in which an adjustment value (horizontal insolation (kWh/m²/d)), determined based on the average horizontal insolation for a week before the desired tender date, is less than 1.0, in which the adjustment value is equal to or greater than 1 and less than 2, in which the adjustment value is equal to or greater than 2 and less than 3, in which the adjustment value is equal to or greater than 3 and less than 4, and in which the adjustment value is equal to or greater than 4 and less than 5.

Also, the tender weight calculation unit 140 may improve the accuracy of the insolation-based weight by calculating a time-based weight.

Here, the tender weight calculation unit 140 may calculate the weight coefficient of the time-based weight by date with reference to meteorological information, as shown in Table 3.

Here, the tender weight calculation unit 140 may select weight coefficients of the time-based weights that represent a time period during which the maximum insolation is measured and a time period during which the minimum insolation is measured on the day for which the weight is requested to be calculated.

Here, the tender weight calculation unit 140 may adjust the weight coefficient of the insolation-based weight using the weight coefficients corresponding to the time period during which the maximum insolation is measured and the time period during which the minimum insolation is measured.

For example, the tender weight calculation unit 140 may adjust the insolation-based weight by multiplying the weight coefficient of the insolation-based weight by the average or the median value of the weight coefficients corresponding to the time period during which the maximum insolation is measured and the time period during which the minimum insolation is measured.

TABLE 3

| | range | | | | |
|---|---|---|---|---|---|
| | | | | 14~18 | 18~20 |
| | 6~8 o'clock | 8~11 o'clock | 11~14 o'clock | o'clock | o'clock |
| weight | 0.6 | 0.8 | 1.3 | 1.0 | 0.7 |

For example, the tender weight calculation unit 140 may select weight coefficients that represent the time period during which the insolation reaches the maximum and the time period during which the insolation reaches the minimum.

Here, the offering amount calculation unit 131 may calculate an offering amount per hour by modifying the average power generation per hour using the weight coefficient.

Here, the offering amount calculation unit 131 may input the calculated offering amount per hour as the initial offering amount.

That is, the offering amount calculation unit 131 may calculate the initial offering amount using the average power generation per hour and the weight coefficients of the season-based weight and the insolation-based weight, which are based on meteorological information of the day before the desired tender date.

Also, the offering amount calculation unit 131 may calculate an adjusted offering amount for the initial offering amount.

That is, the offering amount calculation unit 131 may calculate an adjusted offering amount by modifying the initial offering amount using the weight coefficients of the weather-based weight and the insolation-based weight based on the meteorological information of the desired tender date.

Here, the offering amount calculation unit 131 may check whether there is an increase or decrease in the power generation, which may cause a change in the initial offering amount, by analyzing the weather information and the insolation information of the desired tender date after the initial tender.

For example, if there is more than an hour before the aggregate power plant starts to generate power, the offering amount calculation unit 131 is allowed to calculate the adjusted offering amount once.

Here, when it calculates the adjusted offering amount, the tender weight calculation unit 140 may calculate the weight coefficient of a weather-based weight and the weight coefficient of an insolation-based weight in order to improve the accuracy of the offering amount information.

Here, the tender weight calculation unit 140 may calculate the weather-based weight by analyzing weather information.

For example, the tender weight calculation unit 140 may select the weight coefficient of the weather-based weight that represents weather, as shown in Table 4.

TABLE 4

| | range | | |
|---|---|---|---|
| | cloudy | clear | strong ultraviolet rays |
| weight | 0.5 | 1.0 | 1.4 |

Here, the tender weight calculation unit 140 may calculate the insolation-based weight by analyzing insolation information.

For example, the tender weight calculation unit 140 may calculate the insolation-based weight based on Table 2 and Table 3.

Here, in order to calculate the adjusted offering amount, the tender weight calculation unit 140 may provide the weight coefficients of the weather-based weight and the insolation-based weight of the desired tender date to the offering amount calculation unit 131.

Here, the offering amount calculation unit 131 may update the seasonal offering amount and the hourly offering amount of the small-scale distributed energy resources by inputting the adjusted offering amount to the aggregate profile generation unit 112.

Here, the tender proposal generation unit 132 may generate a tender proposal to be submitted to the power exchange by gathering offering amount information of the small-scale distributed energy resources that form the aggregate power plant.

Here, the tender proposal generation unit 132 may receive meteorological information (for example, insolation information and weather information) from the tender weight calculation unit 140.

Here, the tender proposal generation unit 132 generates an initial tender proposal for the initial offering amount and generates again a tender proposal for the adjusted offering amount, thereby generating a final tender proposal of the aggregate power plant.

For example, not later than an hour before an instruction to generate power is given, if the offering amount is predicted to change, the tender proposal generation unit 132 may generate again a tender proposal for the adjusted offering amount, which is calculated by multiplying the initial offering amount by the weather-based weight and the insolation-based weight, and may deliver the final tender proposal for the adjusted offering amount to the power exchange.

For example, the tender proposal generation unit 132 may generate the initial tender proposal by 9 a.m. on the day before the actual generation of power, which is the day before the desired tender date, and may deliver the initial tender proposal to the power exchange by 10 a.m. on the same day.

The tender history storage unit 133 may store the estimated amount of power generated by each of the small-scale distributed energy resources, the state of the aggregate power plant, and the estimated amount of power to be supplied.

Here, the estimated amount of power to be supplied may correspond to the difference between the estimated amount of power to be generated by the small-scale distributed energy resources and the amount of power demanded by the small-scale energy distributed energy resources.

Here, the tender history storage unit 133 may store the tender proposal of the aggregate power plant, which is generated by the tender proposal generation unit 132.

The tender statistics calculation unit 150 may provide the tender-processing unit 130 with a statistical method for calculating an offering amount and information about the amount of power generated in the past, and may store the calculated offering amount.

Referring to FIG. 5, the tender statistics calculation unit 150 may include a statistics calculation unit 151 and a statistics storage unit 152.

The statistics calculation unit 151 may include a daily statistics calculator, a weekly statistics calculator, and a monthly statistics calculator.

The daily statistics calculator may calculate the sum of order amounts taken by small-scale distributed energy resources included in the aggregate power plant, the sum of offering amounts offered by the small-scale distributed energy resources, the average order amount, and the average offering amount with regards to an order amount and an offering amount for each hour on the day for which the offering amount is to be calculated.

The weekly statistics calculator calculates the sum and average of order amounts and the sum and average of offering amounts for the week including the designated date and for the previous week thereof.

The monthly statistics calculator may generate data about an offering amount of a specific resource by calculating the sum and the average of order amounts and offering amounts for a month.

Here, the offering amount data, calculated by the statistics calculation unit 151, may be used as the offering amount when the offering amount calculation unit 131 operates in the automatic input mode.

The statistics storage unit 152 may store data about the daily, weekly, and monthly sum and average, calculated by the statistics calculation unit 151, therein.

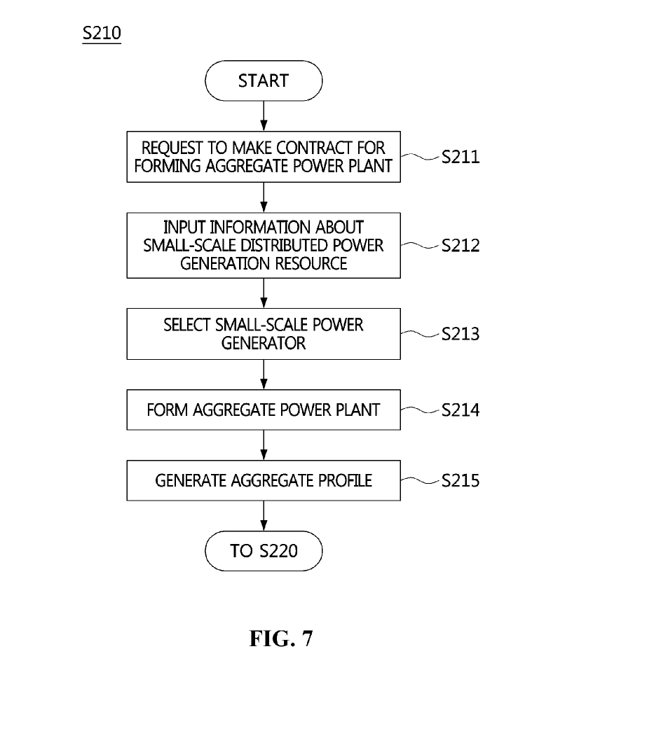

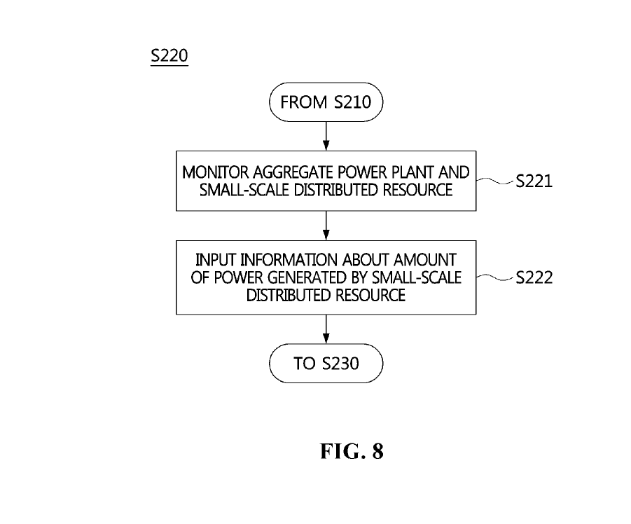

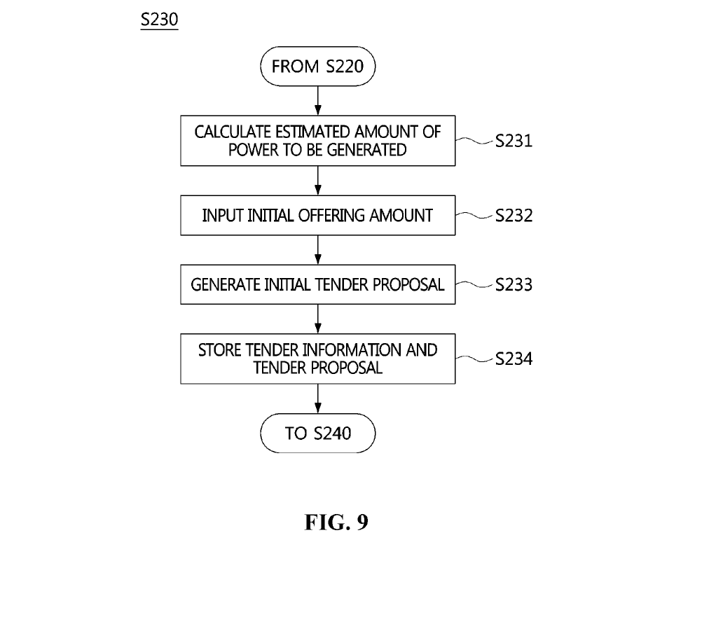

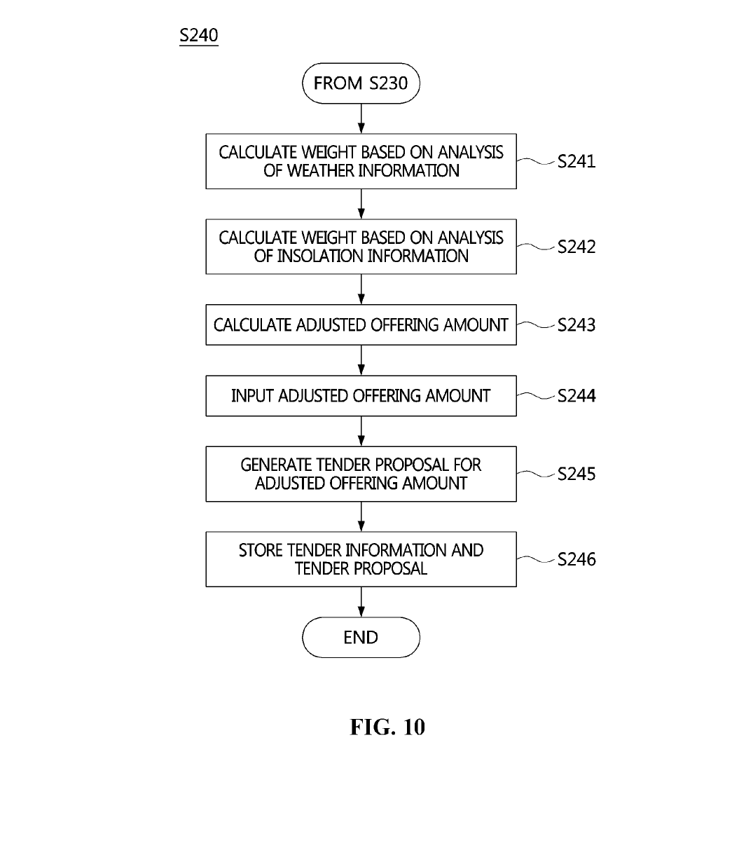

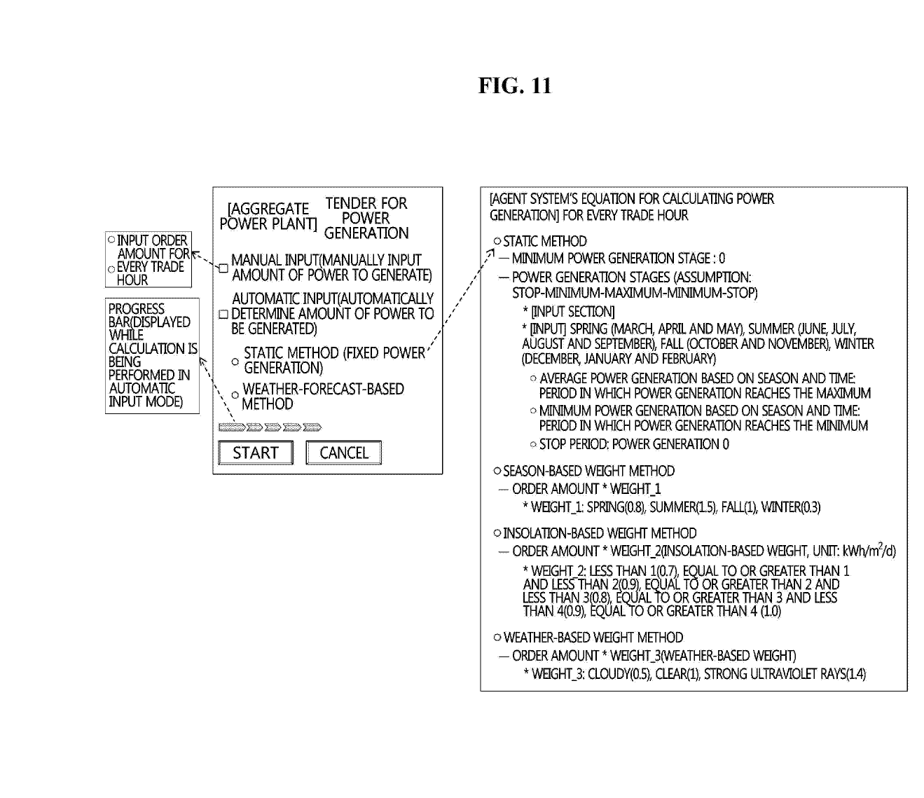

FIG. 6 is a flowchart that shows a method for processing a tender of an aggregate power plant according to an embodiment of the present invention. FIG. 7 is a flowchart that specifically shows an example of the step of forming an aggregate power plant, illustrated in FIG. 6. FIG. 8 is a flowchart that specifically shows an example of the monitoring step, illustrated in FIG. 6. FIG. 9 is a flowchart that specifically shows an example of the step of making an initial tender, illustrated in FIG.6. FIG. 10 is a flowchart that specifically shows an example of the step of changing a tender, illustrated in FIG. 6.

Referring to FIG. 6, in the method for processing a tender of an aggregate power plant according to an embodiment of the present invention, first, an aggregate power plant may be formed at step S210.

Referring to FIG. 7, at step S210, first, a request to enter into a contract for forming an aggregate power plant may be processed at step S211.

That is, the owner of a small-scale distributed energy resource is requested to enter into a contract for forming an aggregate power plant at step S211.

Also, at step S210, information about the small-scale distributed energy resource may be input at step S212.

That is, an electronic contract may be initiated by receiving information about the small-scale distributed energy resource at step S212.

Also, at step S210, the small-scale distributed energy resource may be selected at step S213.

Also, at step S210, the aggregate power plant may be formed at step S214.

That is, the aggregate power plant may be formed at step S214 by selecting the contracted small-scale distributed energy resource.

Here, a small-scale distributed energy resource that is newly contracted or has been contracted in advance is additionally included in the aggregate power plant consisting of one or more small-scale distributed energy resources, whereby an aggregate power plant that matches aggregate power generation characteristics may be formed at step S214.

For example, the aggregate power generation characteristics may be the power generation capacity of small-scale distributed energy resources, the purpose thereof, the region in which the small-scale distributed energy resources are located, and the like.

Here, at step S214, when there is no aggregate power plant that matches the aggregate power generation characteristics, an aggregate power plant may be newly generated and formed by including small-scale distributed energy resources.

Also, at step S210, an aggregate profile may be generated at step S215.

That is, registered information about the formed aggregate power plant may be stored as an aggregate profile at step S215.

Also, in the method for processing a tender of an aggregate power plant according to an embodiment of the present invention, monitoring may be performed at step S220.

Referring to FIG. 8, at step S220, first, the aggregate power plant and the small-scale distributed energy resources may be monitored at step S221.

That is, the state of each of the small-scale distributed energy resources that form the aggregate power plant and the amount of power generated by each of the small-scale distributed energy resources may be monitored in real time at step S221.

Here, at step S221, the small-scale distributed energy resources included in the aggregate power plant are monitored, and the amount of power generated only by the small-scale distributed energy resources that are operating normally may be monitored.

Here, the overall power generation state, including information about whether the power generation state of the aggregate power plant is normal, whether small-scale distributed energy resources included therein are malfunctioning, and the like, may be monitored at step S221.

Here, monitoring of the aggregated power plant and monitoring of the individual small-scale distributed energy resources may be performed in parallel at step S221.

Here, the aggregate profile may be reconfigured at step S221 by changing the composition of the aggregate power plant such that the amount of power generated by the normally operating distributed energy resources matches the installed capacity.

Also, at step S220, information about the amount of power generated by the small-scale distributed energy resources may be input at step S222.

For example, at step S222, information about real-time power generation and cumulative power generation may be collected by reading a power-hour meter, which measures the amount of power generated by each of the small-scale distributed energy resources, every five minutes, and information about the power generation may be input.

Here, at step S222, information about whether each of the distributed energy resources is operating normally is collected and managed, and information about power generation may not be received from a distributed energy resource in an abnormal state or from a distributed energy resource for which regular inspection is being performed.

Also, in the method for processing a tender of an aggregate power plant according to an embodiment of the present invention, an initial tender may be made at step S230.

Referring to FIG. 9, at step S230, first, the estimated amount of power to be generated may be calculated at step S231.

That is, in order to estimate the amount of power to be generated by the aggregate power plant, power generation may be calculated using a power generation calculation algorithm at step S231 after receiving basic data.

Here, the basic data may include information acquired by monitoring the aggregate power plant, information about the amount of power generated by small-scale distributed energy resources, which are currently being monitored, and information about the minimum and maximum power generation capacities, which were input when the small-scale distributed energy resource was contracted for aggregate power generation.

Here, at step S231, an operation mode for calculating an offering amount of the aggregate power plant is selected, and the offering amount may be calculated based on the input information about power generation.

Here, at step S231, the offering amount may be calculated using any of three operation modes.

The three operation modes for calculating the offering amount may include a manual input mode, an automatic input mode, and an automatic adjustment mode.

Also, the mode for inputting and adjusting an offering amount may be input as configuration information when the aggregate power plant is formed, and may be used to identify an offering amount input method when the offering amount is calculated.

Here, at step S231, the owner of a small-scale distributed energy resource may input a desired amount of power to sell (the amount of power to generate) and a desired price thereof using the manual input mode.

Here, at step S231, the amount of power to be sold (the amount of power to be generated) may be automatically calculated using the automatic input mode and the automatic adjustment mode.

Here, at step S231, when the automatic input mode is selected as the operation mode, the method of calculating the amount of power to be sold may vary depending on whether information about the amount of power generated in the corresponding month in past years includes information about the amount of power generated for each hour.

Here, at step S231, in the automatic input mode, if there is information about the amount of power generated in the corresponding month in past years, the year is divided into periods of spring, summer, fall, and winter, and the average power generation per hour for the preset period may be calculated from the past power generation information.

Here, at step S231, in the automatic input mode, the average power generation per hour may be input as the power generation of a maximum stage, among power generation stages.

Here, at step S231, in the automatic input mode, ‘0’ may be input as the power generation of a stop stage, among the power generation stages.

Here, at step S231, in the automatic input mode, the result of multiplying the average power generation per hour by the weight coefficient of a season-based weight may be input as the power generation of a minimum stage, among the power generation stages.

Here, at step S231, in the automatic input mode, when there is no information about the amount of power generated in the past, the average power generation per hour may be calculated from the median value of the maximum and the minimum power generation capacity, which were input when the small-scale distributed energy resource was registered.

Here, the calculated average power generation per hour may be a temporary value.

Here, the accuracy of the initial offering amount, corresponding to the average power generation per hour, which is calculated from the past power generation information, may increase with the accumulation of the power generation information.

Also, at step S230, the initial offering amount may be input at step S232.

That is, the offering amount per hour may be adjusted at step S232.

Here, a weight coefficient for adjusting the offering amount per hour may be calculated at step S232.

Here, at step S232, meteorological information for calculating a weight (for example, insolation information and weather information) may have been stored in advance, or may be provided from a server device for providing meteorological information.

Here, at step S232, a weight coefficient of at least one of a season-based weight, an insolation-based weight, and a weather-based weight may be calculated based on the meteorological information.

Here, at step S232, a weight coefficient for adjusting the average power generation per hour may be calculated and provided to the tender-processing unit 130.

Here, at step S232, a season-based weight, an insolation-based weight, and a time-based weight may be calculated respectively based on the season, insolation, and time.

For example, at step S232, the weight coefficient of the season-based weight for the season in which the desired tender date is included may be calculated.

Here, at step S232, the weight coefficient of the season-based weight that represents the corresponding season may be selected, as shown in Table 1.

For example, the tender weight calculation unit 140 may select the weight coefficient of the season that includes the day for which the weight is requested by the tender-processing unit 130 (for example, the season including the desired tender date and the day before the desired tender date).

Also, at step S232, the weight coefficient of the insolation-based weight may be calculated based on the average horizontal insolation for a preset period (for example, a week) before the desired tender date.

Here, at step S232, the weight coefficient of the insolation-based weight, which represents the range of insolation, may be selected, as shown in Table 2.

For example, the insolation-based weight may be determined to be 0.8, 0.9, 1.0, 1.1, and 1.2 for the respective cases in which an adjustment value (horizontal insolation (kWh/m²/d)), determined based on the average horizontal insolation for a week before the desired tender date, is less than 1.0, in which the adjustment value is equal to or greater than 1 and less than 2, in which the adjustment value is equal to or greater than 2 and less than 3, in which the adjustment value is equal to or greater than 3 and less than 4, and in which the adjustment value is equal to or greater than 4 and less than 5.

Also, at step S232, the accuracy of the insolation-based weight may be improved by calculating a time-based weight.

Here, at step S232, the weight coefficient of the time-based weight by date may be calculated with reference to meteorological information, as shown in Table 3.

Here, at step S232, the weight coefficients of the time-based weights that represent a time period during which the maximum insolation is measured and a time period during which the minimum insolation is measured on the day for which the weight is requested to be calculated may be selected.

Here, at step S232, the weight coefficient of the insolation-based weight may be adjusted using the weight coefficients corresponding to the time period during which the maximum insolation is measured and the time period during which the minimum insolation is measured.

For example, at step S232, the insolation-based weight may be modified by multiplying the weight coefficient of the insolation-based weight by the average or the median value of the weight coefficients corresponding to the time period during which the maximum insolation is measured and the time period during which the minimum insolation is measured.

For example, at step S232, the weight coefficients that represent the time period during which the insolation reaches the maximum and the time period during which the insolation reaches the minimum may be selected.

Here, at step S232, the offering amount per hour may be calculated by adjusting the average power generation per hour using the weight coefficient.

Here, at step S232, the calculated offering amount per hour may be input as the initial offering amount.

That is, at step S232, the initial offering amount may be calculated using the average power generation per hour, and the weight coefficients of the season-based weight and the insolation-based weight, which are based on meteorological information of the day before the desired tender date.

Also, at step S230, an initial tender proposal may be generated at step S233.

That is, at step S233, the offering amount information of the small-scale distributed energy resources that form the aggregate power plant is collected, and a tender proposal to be submitted to the power exchange may be generated therefrom.

For example, the initial tender proposal may be generated by 9 a.m. on the day before the actual generation of power, which is the day before the desired tender date, and may be registered in the power exchange by 10 a.m. on the same day.

Also, at step S230, information about the tender and the tender proposal may be stored at step S234.

That is, at step S234, the estimated amount of power to be generated per hour by each of the small-scale distributed energy resources, the state of the aggregate power plant, and the estimated amount of power to be supplied by the aggregate power plant may be stored.

Here, the estimated amount of power to be supplied may be the difference between the estimated amount of power to be generated and the amount of power demanded by the small-scale distributed energy resources.

Here, at step S234, the initial tender proposals generated for the respective aggregate power plants may be stored.

Here, at step S234, the statistical method for calculating an offering amount and the information about the amount of power generated in the past may be provided, and the tender proposal based on the calculated initial offering amount may be stored.

Also, in the method for processing a tender of an aggregate power plant according to an embodiment of the present invention, the tender may be changed at step S240.

That is, at step S240, using the automatic adjustment mode, an adjusted offering amount may be calculated from the initial offering amount.

Here, at step S240, when the adjusted offering amount is calculated, the weight coefficient of a weather-based weight and the weight coefficient of an insolation-based weight may be calculated first in order to improve the accuracy of the offering amount information.

Referring to FIG. 10, at step S240, first, a weight based on the analysis of weather information may be calculated at step S241.

That is, at step S241, the weather-based weight may be calculated by analyzing weather information.

For example, at step S241, the weight coefficient of the weather-based weight, which represents weather information, may be selected, as shown in Table 4.

Also, at step S240, a weight based on the analysis of insolation information may be calculated at step S242.

That is, at step S242, an insolation-based weight may be calculated by analyzing insolation information.

For example, the tender weight calculation unit 140 may calculate the insolation-based weight based on Table 2 and Table 3.

Also, at step S240, an adjusted offering amount may be calculated at step S243.

That is, the initial offering amount may be modified using the weather-based weight and the insolation-based weight at step S243.

Here, at step S243, the adjusted offering amount may be calculated by modifying the initial offering amount using the weight coefficients of the weather-based weight and the insolation-based weight based on the meteorological information of the desired tender date.

Here, at step S243, in order to calculate the adjusted offering amount, the weight coefficients of the weather-based weight and the insolation-based weight of the desired tender date may be provided to the offering amount calculation unit 131.

Here, at step S243, after the tender is closed, whether there is an increase or decrease in the power generation, which may cause a change in the initial offering amount, may be checked by analyzing the weather information and the insolation information.

For example, at step S243, if there is more than an hour before the aggregate power plant starts to generate power, the calculation of an adjusted offering amount may be allowed once.

Also, at step S240, the adjusted offering amount may be input at step S244.

That is, at step S244, the adjusted offering amount, acquired by modifying the initial offering amount, may be input.

Also, at step S240, a tender proposal for the adjusted offering amount may be generated at step S245.

That is, at step S245, a tender proposal may be generated again using the modified offering amount, and the final tender proposal acquired therefrom may be delivered to the power exchange.

For example, at step S245, not later than an hour before an instruction to generate power is given, if the offering amount is expected to change, a tender proposal may be generated again for the adjusted offering amount, which is calculated by multiplying the initial offering amount by the weather-based weight and the insolation-based weight, and the final tender proposal for the adjusted offering amount may be delivered to the power exchange.

Also, at step S240, information about the tender and the tender proposal may be stored at step S246.

That is, at step S246, the estimated amount of power to be generated, which is modified using the adjusted offering amount, the state of the aggregated power plant, and the estimated amount of power to be supplied, may be stored.

Here, at step S246, the tender proposals, generated again for the adjusted offering amount, may be stored for the respective aggregate power plants.

Here, at step S246, the statistical method for calculating an offering amount and information about the amount of power generated in the past may be provided, and the offering amount calculated based thereon may be stored.

Here, at step S246, the adjusted offering amount is input to the aggregate profile generation unit 112, whereby a seasonal offering amount and an hourly offering amount of the small-scale distributed energy resources may be updated.

FIG. 11 is a view that shows an interface for selecting an operation mode for calculating an offering amount of an aggregate power plant according to an embodiment of the present invention.

FIG. 11 shows a user interface through which an operation mode for a tender for power generation of an aggregate power plant is selected.

An offering amount calculation mode and an offering amount calculation method according to an embodiment of the present invention may include a manual input mode, an automatic input mode, and an automatic adjustment mode.

The manual input mode enables the owner of a small-scale distributed energy resource to input the desired amount of power to sell per hour and the desired price thereof.

The automatic input mode automatically determines the amount of power to be generated. Here, the year is divided into periods corresponding to spring, summer, fall, and winter, and power generation per hour, acquired from past power generation information, may be input for each period.

A static calculation algorithm may categorize power generation stages into a stop stage, a maximum stage, and a minimum stage, and may arrange the stop stage, the minimum stage, the maximum stage, the minimum stage, and the stop stage over 24 hours in the order in which they are listed above.

Here, if there is information about the amount of power generated in the corresponding month in the past years, the static calculation algorithm divides the year into periods of spring, summer, fall, and winter, and calculates the average power generation per hour for the preset period using the past power generation information.

Here, in the static calculation algorithm, the average power generation per hour may be input as the power generation of the maximum stage, among the power generation stages.

Here, in the static calculation algorithm, ‘0’ may be input as the power generation of the stop stage, among the power generation stages.

Here, in the static calculation algorithm, the result of multiplying the average power generation per hour by the weight coefficient of a season-based weight may be input as the power generation of the minimum stage, among the power generation stages.

An automatic weather-forecast-based calculation algorithm may include a season-based weight method, an insolation-based weight method, and a weather-based weight method.

In the season-based weight method, an offering amount per hour may be modified by multiplying the offering amount (order amount) per hour by the weight coefficient of the season-based weight.

In the insolation-based weight method, an offering amount per hour may be modified by multiplying the offering amount per hour by the weight coefficient of the insolation-based weight.

In the weather-based weight method, an offering amount per hour may be modified by multiplying the offering amount per hour by the weight coefficient of the weather-based weight depending on the next day's weather information.

The season-based weight method and the insolation-based weight method may be used when an initial offering amount is calculated.

The weather-based weight method and the insolation-based weight method may be used when an adjusted offering amount is calculated by modifying the initial offering amount.

The values illustrated in FIG. 11 may be used as the weight coefficients, but without limitation thereto, the values may be set differently depending on settings made by a user.

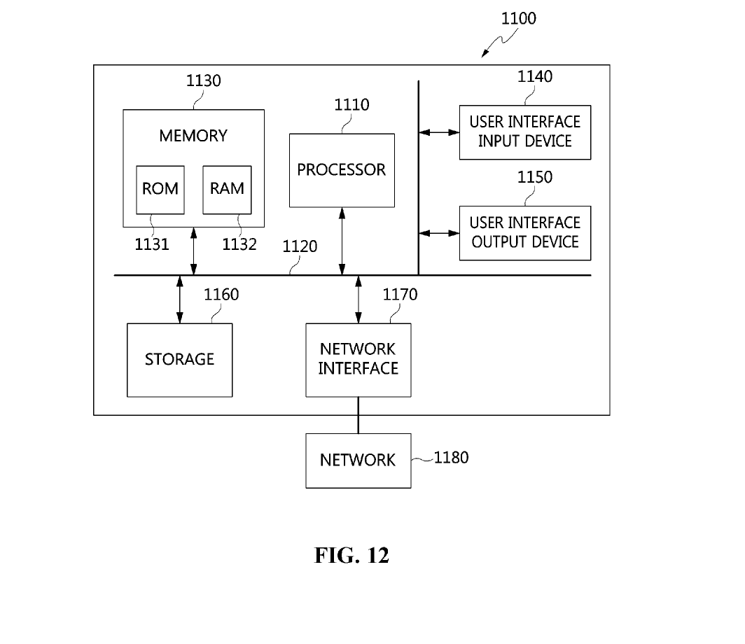

FIG. 12 is a block diagram that shows a computer system according to an embodiment of the present invention.

Referring to FIG. 12, the apparatus 100 for processing a tender of an aggregate power plant according to an embodiment of the present invention may be implemented in a computer system 1100 including a computer-readable recording medium. As illustrated in FIG. 12, the computer system 1100 may include one or more processors 1110, memory 1130, a user interface input device 1140, a user interface output device 1150, and storage 1160, which communicate with each other via a bus 1120. Also, the computer system 1100 may further include a network interface 1170 connected with a network 1180. The processor 1110 may be a central processing unit or a semiconductor device for executing processing instructions stored in the memory 1130 or the storage 1160. The memory 1130 and the storage 1160 may be various types of volatile or nonvolatile storage media. For example, the memory may include ROM 1131 or RAM 1132.

The present invention enables participation in a tender for power generation by inputting and storing an offering amount in an aggregate power plant depending on a selected power amount input mode.

Also, the present invention may form an aggregate power plant such that small-scale distributed energy resources participate in a power trade market and are used as power generation resources even though they are difficult to manage.

Also, the present invention may provide various input modes for a tender of an aggregated power plant.

As described above, the apparatus and method for processing a tender of an aggregate power plant according to the present invention are not limitedly applied to the configurations and operations of the above-described embodiments, but all or some of the embodiments may be selectively combined and configured, so that the embodiments may be modified in various ways.

What is claimed is:

1. An apparatus for processing a tender of an aggregate power plant, comprising:
an aggregate power plant configuration management unit for generating an aggregate profile by forming an aggregate power plant by grouping distributed energy resources for participating in a power market;
a monitoring unit for reconfiguring the aggregate profile by monitoring the distributed energy resources;
a tender-processing unit for calculating an offering amount of the aggregate power plant using the aggregate profile; and
a tender weight calculation unit for calculating a weight coefficient based on meteorological information in order to adjust the offering amount, and providing the weight coefficient to the tender-processing unit.

2. The apparatus of claim 1, wherein the tender weight calculation unit calculates a weight coefficient of at least one of a season-based weight, an insolation-based weight, and a weather-based weight based on the meteorological information.

3. The apparatus of claim 2, wherein the tender weight calculation unit calculates the weight coefficient of the insolation-based weight based on average horizontal insolation during a preset period before a day for which a weight is requested to be calculated.

4. The apparatus of claim 3, wherein the tender weight calculation unit adjusts the insolation-based weight using a weight coefficient of a time-based weight, which is calculated from information about insolation for each hour on the day for which the weight is requested to be calculated with reference to the meteorological information.

5. The apparatus of claim 2, wherein the tender-processing unit calculates the offering amount in such a way that an initial offering amount is calculated based on meteorological information of a day before a desired tender date and an adjusted offering amount is calculated by adjusting the initial offering amount based on meteorological information of the desired tender date.

6. The apparatus of claim 5, wherein the tender-processing unit calculates average power generation per hour for each season using the previously stored information about an amount of power generated by the aggregate power plant in past.

7. The apparatus of claim 6, wherein, when there is no information about the amount of power generated by the aggregate power plant in the past, the tender-processing unit calculates the average power generation per hour for each season using a maximum and a minimum power generation capacity of the distributed energy resources that form the aggregate power plant.

8. The apparatus of claim 7, wherein the tender-processing unit calculates the initial offering amount using the average power generation per hour and the weight coefficients of the season-based weight and the insolation-based weight based on the meteorological information of the day before the desired tender date.

9. The apparatus of claim 8, wherein the tender-processing unit calculates the adjusted offering amount by adjusting the initial offering amount using the weight coefficients of the weather-based weight and the insolation-based weight based on the meteorological information of the desired tender date.

10. The apparatus of claim 9, wherein the tender-processing unit generates a final tender proposal of the aggregate power plant by generating an initial tender proposal for the initial offering amount and generating a tender proposal again for the adjusted offering amount.

11. A method for processing a tender of an aggregate power plant, in which an apparatus for processing a tender of an aggregate power plant is used, the method comprising:
generating an aggregate profile by forming an aggregate power plant by grouping distributed energy resources for participating in a power market;
reconfiguring the aggregate profile by monitoring the distributed energy resources; and
calculating an offering amount of the aggregate power plant using the aggregate profile.

12. The method of claim 11, wherein calculating the offering amount is configured to calculate a weight coefficient of at least one of a season-based weight, an insolation-based weight, and a weather-based weight based on meteorological information.

13. The method of claim 12, wherein calculating the offering amount is configured to calculate the weight coefficient of the insolation-based weight based on average horizontal insolation during a preset period before a day for which a weight is requested to be calculated.

14. The method of claim 13, wherein calculating the offering amount is configured to adjust the insolation-based weight using a weight coefficient of a time-based weight, which is calculated from information about insolation for each hour on the day for which the weight is requested to be calculated with reference to the meteorological information.

15. The method of claim 12, wherein calculating the offering amount is configured to calculate the offering amount in such a way that an initial offering amount is calculated based on meteorological information of a day before a desired tender date and an adjusted offering amount is calculated by adjusting the initial offering amount based on meteorological information of the desired tender date.

16. The method of claim 15, wherein calculating the offering amount is configured to calculate average power generation per hour for each season using the previously stored information about an amount of power generated by the aggregate power plant in past.

17. The method of claim 16, wherein calculating the offering amount is configured to calculate the average power generation per hour for each season using a maximum and a minimum power generation capacity of the distributed energy resources that form the aggregate power plant when there is no information about the amount of power generated by the aggregate power plant in the past.

18. The method of claim 17, wherein calculating the offering amount is configured to calculate the initial offering amount using the average power generation per hour and the weight coefficients of the season-based weight and the insolation-based weight based on the meteorological information of the day before the desired tender date.

19. The method of claim 18, wherein calculating the offering amount is configured to calculate the adjusted offering amount by adjusting the initial offering amount using the weight coefficients of the weather-based weight and the insolation-based weight based on the meteorological information of the desired tender date.

20. The method of claim 19, wherein calculating the offering amount is configured to generate a final tender proposal of the aggregate power plant by generating an initial tender proposal for the initial offering amount and generating a tender proposal again for the adjusted offering amount.
